(19) United States
(12) Patent Application Publication
(10) Pub. No.: US 2025/0350782 A1
(43) Pub. Date: Nov. 13, 2025

(54) CONTENT ITEM RECOMMENDATIONS

(71) Applicant: ROKU, INC., San Jose, CA (US)

(72) Inventors: Atishay JAIN, San Bruno, CA (US); Fei XIAO, San Jose, CA (US); Abhishek BAMBHA, Burlingame, CA (US); Rihit MAHTO, San Jose, CA (US); Ronica JETHWA, Mountain View, CA (US); Nam VO, San Jose, CA (US); Lian LIU, San Jose, CA (US); Pulkit AGGARWAL, San Jose, CA (US); Jose SANCHEZ, San Jose, CA (US)

(73) Assignee: Roku, INC, San Jose, CA (US)

(21) Appl. No.: 18/659,542

(22) Filed: May 9, 2024

(51) Int. Cl. H04N 21/25; H04N 21/258

(52) U.S. Cl. CPC H04N 21/251; H04N 21/25866

(57) ABSTRACT

Disclosed herein are system, apparatus, article of manufacture, method and/or computer program product embodiments, and/or combinations and sub-combinations thereof, for generating a recommendation for a media content of a first form of content based on user interactions with a second form of content. The first form of content is of a different length than the second form of content. An example embodiment operates by determining interaction based data associated with a second form of content based on a user interaction with a first media content. The interaction based data are provided to a machine learning model along with historical data indicative of a user behavior with media contents of the first form or the second form of contents, and metadata associated with the first media content. The machine learning model outputs a second media content of the first form.

### BACKGROUND

### FIELD

This disclosure is generally directed to computer-implemented systems that generate recommendations for media content items.

### SUMMARY

Provided herein are system, apparatus, article of manufacture, method and/or computer program product embodiments, and/or combinations and sub-combinations thereof, for generating a recommendation for a media content of a first form of content based on user interactions with a second form of content. The first form of content is of a different length than the second form of content. An example embodiment operates by determining interaction based data associated with a second form of content based on a user interaction with a first media content. The interaction based data are provided to a machine learning model along with historical data indicative of a user behavior with media contents of the first form or the second form of contents, and metadata associated with the first media content. The machine learning model outputs a second media content of the first form.

In some aspects, additional interaction based data associated with the first form of content is determined based on interactions of the user with the second media content. The machine learning model is retrained based on the additional interaction based data.

In some aspects, the interaction based data associated with the second form of content and the additional interaction based data associated with the first form of content are transformed to a common representation.

In some aspects, the first form of content is a short form of content and the second form of content is a long form content.

In some aspects, a media content of the first form of content is a subset of a media content of the second form of contents.

In some aspects, the machine learning model includes a sequential machine learning model.

In some aspects, the output of the machine learning model comprises a sequence of short form video contents.

In some aspects, the metadata associated with the first media content represents one of: a title of the first media content item; a category of the first media content item; a genre of the first media content item; a rating of the first media content; or cast information.

### BRIEF DESCRIPTION OF THE FIGURES

The accompanying drawings are incorporated herein and form a part of the specification.

FIG. 1 illustrates a block diagram of a multimedia environment, according to some embodiments.

FIG. 2 illustrates a block diagram of a streaming media device, according to some embodiments.

FIG. 3 illustrates a block diagram of a content recommendation module, according to some embodiments.

FIG. 4 illustrates a block diagram of a sequential machine learning model, according to some embodiments.

FIG. 5 illustrates a flow diagram of a method for recommending a media content, according to some embodiments.

FIG. 6 illustrates a flow diagram of a method for training a machine learning model, according to some embodiments.

FIG. 7 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Recommendation systems attempt to identify and recommend items of interest for a user from a vast catalog of items. Recommendations systems may use past interactions of the user with the items to generate the recommendation. Such recommendation systems suffer from a cold start problem when a new form of contents is added to the catalog of items, where no past interactions for the new form of contents exist. In addition, interactions for the new form of contents may not be easily acquired or collected.

The catalog of items may include content of a first form and contents of a second form may be added to the catalog of items. In some aspects, the first form of contents and the second form contents may differ by one or more aspects (e.g., duration of the content, data complexity of the content, number of available contents in each form). For example, the catalog of items may include long form contents and short form contents may be added to the catalog of items. Long form contents may refer to contents having a longer time duration than short form content. For example, long form contents may refer to contents that have a duration greater than 30 minutes. Short form contents may refer to contents having a duration of less than 10 minutes. In some aspects, the short form contents may refer to contents having a duration of less than one minute. In addition, the catalog of items may include mid-length form content. Mid-length form contents may refer to contents having a duration of less than 30 minutes.

Short form contents are gaining popularity in the streaming world and millions of short form videos are uploaded to a variety of platforms. Challenges arise when generating recommendations of different types of short form content to the user. First, user interactions with short from contents may be harder to acquire compared to interactions with long form contents. Since short form contents have a shorter duration compared to long form content, it is challenging to accurately deduce a user taste and/or preferences for short form contents. For example, because of the short duration of short form content compared to long form content, there is no time commitment from the user. The user may interact with the short form content even if the user does not like the short form content. For example, the user may stop watching a movie if the user does not like the movie but may continue watching the short form content even if the user does not like the content as the duration may be less than one minute. Thus, there is a lack of data about user interactions and behaviors with short form contents.

Another challenge is that the quality of short form interaction data may be lower compared to the quality of long form interaction data. For example, if a user commits to watching a long form content and indeed does so, it indicates a greater affinity of the user to that particular type of content. In the short form content realm, since the duration of the content is short it is not always possible to “implicitly” deduce negative or positive interactions. In addition, because multiple short contents may be played consequentially without the user interacting, it is challenging to deduce interactions with one of the short form content. For example, recommendation system may keep generating media contents of the same genre due to the lack of interactions from the user. Thus, the recommendation system may suffer from lack of quality data even after the short form contents are added to the catalog and user interactions for the short form contents are collected.

Embodiments described herein may address some or all of the foregoing technical issues that relate to recommendation systems. By leveraging long form content data (e.g., user interactions with long form contents), the embodiments described herein solve the aforementioned cold start problem, as interactions with other forms of contents may be utilized to make recommendations for the user. Embodiments may recommend a series of short form contents that are presented to the user. Using long form content data to provide short form content recommendation provides more accurate recommendations. For instance, rich data around user interactions and user behaviors with long content form are inputted to a machine learning model that is trained to generate a recommendation that includes a short form content to the user.

Historical data associated with short form contents and long form contents are provided as input to the machine learning model. In some aspects, the inputs may be formatted using one or more models before being provided to the machine learning model. The machine learning model may be a sequential model that receives a series of media items that the user interacted and may generate a recommendation of a sequence of short form contents. In addition, the historical data are provided to the sequential model. A latent space of the machine learning model may extract features from the inputs that may affect the recommendation. The machine learning model is trained to extract the features from the inputs (e.g., contents) that provide accurate recommendations.

Using long form content data solves the technical challenge associated with the memory requirement for generating recommendations for short form contents. The number of short form contents is very large compared to the long form contents. Thus, generating recommendations based on short form contents may not be feasible due to the memory requirement. By using long form contents to generate the recommendation for short form content, the memory requirement is reduced. Thus, the inputs associated with short form contents are transformed and configured such as the machine learning model may be efficiently be trained using the data. In addition, the infrastructure cost is reduced.

In some embodiments, a content may be a media content. The media content may be a video content, an audio content, or a written content. The video content may be a movie, a series, a live stream, and the like. The audio content may include music, songs, podcasts, and the like. The written contents may include electronic books, blogs, and the like.

In some aspects, the short form content may be associated with a long form content. For example, the short form content may be a subset of the long form content. For example, the long form content may be an electronic book and the short form content may be an extract from the electronic book. In another example, the long form content may be a movie and the short form content may be one or more scenes from the movie. In yet another example, the long form content may be a song or an instrumental composition and the corresponding short form content may be a part of the song (e.g., a chorus). In some aspects, the short form content may be a video content associated with another video content of long form content. For example, the video content may be a video that comprises a review of a movie. The video may be a user-generated content that provides a review of the movie.

The short form contents may be presented to the user as a dynamic playlist where the short form contents are played one after another. For example, a series of short form video may be continuously played to the user without an input from the user.

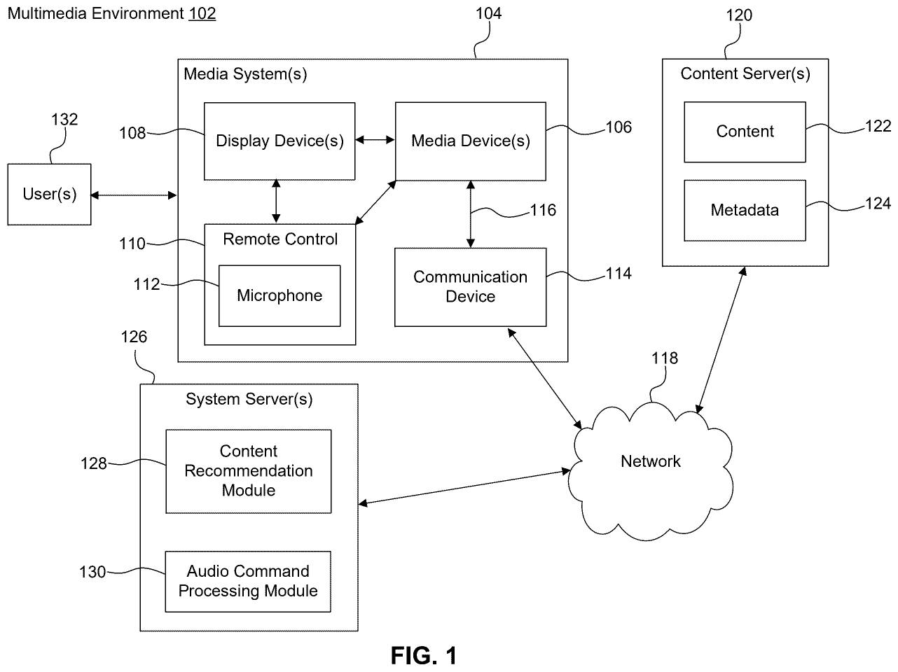

Various embodiments of this disclosure may be implemented using and/or may be part of a multimedia environment 102 shown in FIG. 1. It is noted, however, that multimedia environment 102 is provided solely for illustrative purposes, and is not limiting. Embodiments of this disclosure may be implemented using and/or may be part of environments different from and/or in addition to multimedia environment 102, as will be appreciated by persons skilled in the relevant art(s) based on the teachings contained herein. An example of multimedia environment 102 shall now be described.

### Multimedia Environment

FIG. 1 illustrates a block diagram of multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media.

Multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, and/or digital video recording device, to name just a few examples. Display device 108 may be a monitor, television (TV), computer, smart phone, tablet, wearable (such as a watch or glasses), appliance, internet of things (IoT) device, and/or projector, to name just a few examples. In some embodiments, media device 106 can be a part of, integrated with, operatively coupled to, and/or connected to its respective display device 108.

Each media device 106 may be configured to communicate with network 118 via a communication device 114. Communication device 114 may include, for example, a cable modem or satellite TV transceiver. Media device 106 may communicate with communication device 114 over a link 116, wherein link 116 may include wireless (such as WiFi) and/or wired connections.

In various embodiments, network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. Remote control 110 can be any component, part, apparatus and/or method for controlling media device 106 and/or display device 108, such as a remote control, a tablet, a laptop computer, a smartphone, a wearable, on-screen controls, integrated control buttons, audio controls, or any combination thereof, to name just a few examples. In an embodiment, remote control 110 wirelessly communicates with media device 106 and/or display device 108 using cellular, Bluetooth, infrared, etc., or any combination thereof. Remote control 110 may include a microphone 112, which is further described below.

Multimedia environment 102 may include a plurality of content servers 120 (also called content providers, channels or sources 120). Although only one content server 120 is shown in FIG. 1, in practice multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, software, and/or any other content or data objects in electronic form. Content 122 may include short form contents and long form contents. In addition, short from contents may include user-generated contents (UGCs).

In some embodiments, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining or relating to the content 122. Metadata 124 may also or alternatively include one or more indexes of content 122. In some embodiments, metadata 124 may include tags for user-generated contents.

Multimedia environment 102 may include one or more system servers 126. System servers 126 may operate to support media devices 106 from the cloud. It is noted that the structural and functional aspects of system servers 126 may wholly or partially exist in the same or different ones of system servers 126.

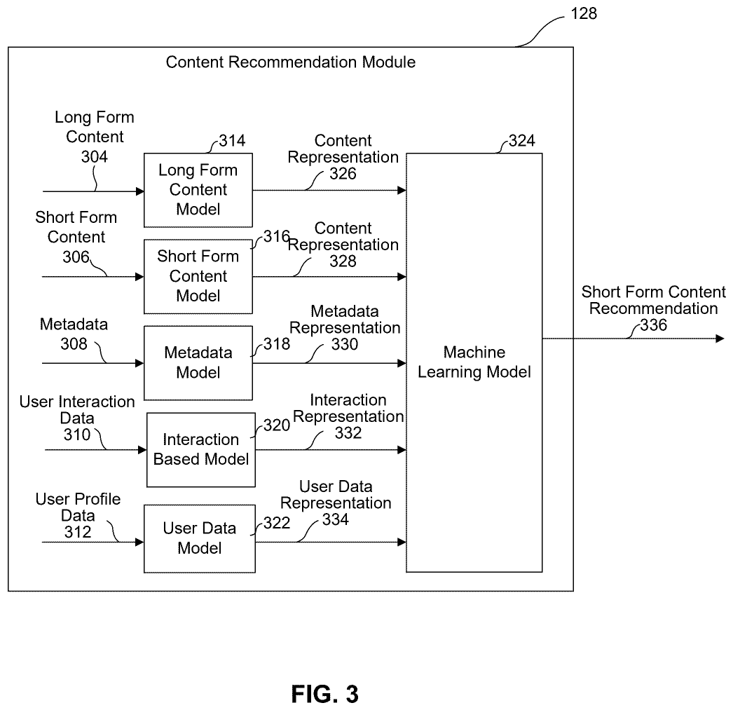

System servers 126 may include a content recommendation module 128 that provides a media content item recommendations for a user (e.g., a consumer of media content items). The recommendation may be for a content form that the user has not previously interacted with. For example, content recommendation module 126 may recommend a media content corresponding to a short form content. The recommended item may be output, for example, via a GUI of media device(s) 106. In some aspects, the recommended item may be output without further interactions from the user. In some aspects, a representation of the recommended item may be presented to the user. The user may select and consume the recommended item. Content recommendation module 128 may use user interactions associated with historical long form content (e.g., 10 last long form contents watched by the user) to generate the recommended item or content. Additional details regarding content recommendation module 128 are described below with reference to FIG. 3.

System servers 126 may also include an audio command processing module 130. As noted above, remote control 110 may include microphone 112. Microphone 112 may receive audio data from users 132 (as well as other sources, such as display device 108). In some embodiments, media device 106 may be audio responsive, and the audio data may represent verbal commands from user 132 to control media device 106 as well as other components in the media system 104, such as the display device 108.

In some embodiments, the audio data received by microphone 112 in remote control 110 is transferred to media device 106, which is then forwarded to audio command processing module 130 in system servers 126. Audio command processing module 130 may operate to process and analyze the received audio data to recognize user 132′s verbal command. Audio command processing module 130 may then forward the verbal command back to media device 106 for processing. Audio command processing module 130 may also operate to process and analyze the received audio data to recognize a spoken query of user 132. Audio command processing module 130 may then forward the spoken query to content item recommendation component 128 for processing. For example, the spoken query may include an input to content recommendation module 128. For example, the input may include a genre of short form contents that the user desires to consume.

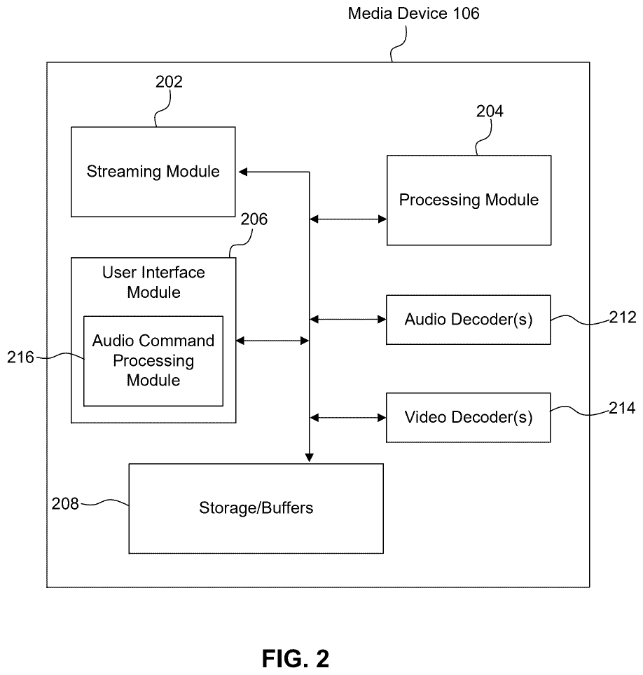

In some embodiments, the audio data may be alternatively or additionally processed and analyzed by an audio command processing module 216 in media device 106 (see FIG. 2). Media device 106 and system servers 126 may then cooperate to pick one of the verbal commands to process (either the verbal command recognized by audio command processing module 130 in system servers 126, or the verbal command recognized by audio command processing module 216 in media device 106).

FIG. 2 illustrates a block diagram of an example media device 106, according to some embodiments. Media device 106 may include a streaming module 202, a processing module 204, storage/buffers 208, and user interface module 206. As described above, user interface module 206 may include audio command processing module 216.

Media device 106 may also include one or more audio decoders 212 and one or more video decoders 214.

Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, H.265, AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some embodiments, user 132 may interact with media device 106 via, for example, remote control 110. For example, user 132 may use remote control 110 to interact with user interface module 206 of media device 106 to select content, such as a movie, TV show, music, book, application, game, etc. Streaming module 202 of media device 106 may request the selected content from content server(s) 120 over network 118. Content server(s) 120 may transmit the requested content to streaming module 202. Media device 106 may transmit the received content to display device 108 for playback to user 132.

In streaming embodiments, streaming module 202 may transmit the content to display device 108 in real time or near real time as it receives such content from content server(s) 120. In non-streaming embodiments, media device 106 may store the content received from content server(s) 120 in storage/buffers 208 for later playback on display device 108.

### Media Content Item of a First Form Recommendation Based on User interaction with a Second Form of Content

FIG. 3 illustrates a block diagram of content recommendation module 128, according to some embodiments. As noted above, in certain embodiments, content recommendation module 128 may be implemented by system server(s) 126 in multimedia environment 102 of FIG. 1. In other embodiments, content recommendation module 128 may be implemented by media device(s) 106.

As shown in FIG. 3, content recommendation module 128 comprises a long form content model 314, a short form content module 316, a metadata model 318, an interaction based model 320, a user data model 322, and a machine learning model 324.

Long form content model 314 may receive long form content 304 and generate content representation 326. Long form content 304 may represent historical contents that are of the long form that the user has interacted with (e.g., watched, liked). In some aspects, the historical contents may represent the content that the user interacted with within a predetermined period (e.g., last one month, last quarter, or last year). In some aspects, the historical contents may represent a predefined number of contents that the user interacted with (e.g., last N contents of the long form). As described above, long form content may refer to media content that have a duration of 10 minutes or more (e.g., movies, series, books, podcasts).

Long form content model 314 may generate content representation 326 using a representation algorithm such as tf-idf (e.g., a vector space representation) that abstracts the features of long form contents 304. A label indicating that the content representation 326 correspond to long form content may be provided to machine learning model 324 along with content representation 326.

Short form content model 316 may receive as input short form content 306 and generate content representation 328. As discussed above, short form contents may refer to contents having a time duration less than long form contents. For example, short form contents may refer to contents having a time duration of less than 10 minutes. In some aspects, short form contents may refer to contents having a duration of less than one minute. In some aspects, the short content form may be associated with a long form content. For example, the short movie content may include clips or scenes from a movie. For short content that are associated a respective long form content, the user may be given an option to navigate to the long form content. Short form content model 316 may generate content representation 328 using a representation algorithm such as tf-idf.

Metadata model 318 may generate a metadata representation 330 for a particular media content from long form content 304 or short form content 306 based on metadata 308. Metadata 308 may be formatted prior to being input to metadata model 318. Metadata 308 may be in the form of one or more data structures representative of various metadata associated with the particular media content. Metadata 308 may include one or more of a title of the media content item, a category of the media content item, a genre of the media content item, a rating of the media content, a duration of the media content, or cast information. In some aspects, metadata module 318 may generate an embedding representative of the particular media content. In some aspects, metadata model 318 may be a neural network (e.g., a graph neural network (GNN)). Metadata representation 330 is provided as input to machine learning model 324 with the corresponding content representation 326 of long form content 304 or content representation 328 of short form content 306. In some aspects, a subset of the metadata may be provided to machine learning model 324. For example, metadata representation 330 may be generated for a subset of metadata 308 available for the particular media content.

Interaction based model 320 may be configured to generate interaction representation 332 for one or more media contents of long form content 304 or short form content 306 for which the user has previously interacted with. Interaction based model 320 may generate interaction representation 332 based on user interaction data 310. User interactions may be used to determine a user taste. For example, a level of interest of the user with a genre of media content. A user taste or level of interest identified based on long form content may be used in generating the recommendation for short form content. For example, if a user enjoys watching “comedy” movies, content recommendation module 128 may also recommend short form media content associated with “comedy”.

User interaction data 310 may include user interactions and user behaviors associated with long form content. Interactions with long form contents may include interactions with metadata associated with the media content presented to the user (e.g., description about the movie) and interactions while the media content is being consumed. The interactions may include positive interactions and negative interactions. Examples of interactions may include a user clicking on or otherwise interacting with a GUI control to obtain information about a media content, a user selecting the media content for playback, a user pausing a video content at a frame and fast forwarding from the frame, a user rewinding to a particular scene of a video content, and a user playing the video content multiple times. In some aspects, interaction representation 332 may be an embedding representative of user interaction data 310. Interaction based model 320 may be a GNN, a sequential model, a transformer model, or the like.

In some aspects, interactions with short form contents may include explicit signals (e.g., commenting with a “heart” icon, pressing a “thumb up” button). However, as discussed above, the user may not interact with short form contents or provide explicit signal even if the user enjoys the contents. In some aspects, interactions with short form contents may include implicit signals from the user (e.g., navigating to a tile that presents short form contents).

Although interactions with short form contents may differ from interactions with long form contents, interaction based model 320 may transform the interactions to similar representations (e.g., embeddings) such that user interaction data for both short form content and long form contents may be fused together and fed to machine learning model 324.

In some aspects, implicit signals may be determined based on a user play behavior. For example, a short form media content may be associated with a long form media content. By interacting with the GUI to navigate or to play the corresponding long form media content, the implicit signal may be deduced. Interaction representation 332 may be similar to navigating from a description of a long form media content to playing the long form content media. Interaction representation 332 may be assigned different weights. For example, if a user navigate from the short form media content to the corresponding long form content but does not play the corresponding long form content a lower weight may be assigned even if the user navigated to the description.

User data model 332 may be configured to generate user data representation 334 based on user profile data 312. User profile data 312 may include historical data associated with the user. User data model 332 may determine one or more user metrics indicative of a user behavior based on the user profile data 312. In some aspects, the user metric may represent an average of a percentage of the media content consumed by the user before stopping or pausing. For example, for a video media content the user metric may indicate the percentage duration that the user consumes before stopping the movie. The user metric may be based on historical data. For example, the historical data may include for each video content (e.g., movie) watched by the user, the duration consumed by the user with respect to the total duration of the video content. User data model 322 may determine the average of the proportion. For example, a first user may on average consume 95% of the content while a second average may skip or stop watching after 75%. The user metric is provided to machine learning model 324 to provide individualized representation of the user behavior. Thus, if the user metric indicates that the average of the first user is 95%, then stopping the content at 75% may indicate that the first user did not like the content. While for a second user having an average of 70%, stopping the content at 75% does not indicate that the second user did not like the content. The metrics determined using associated with long form content 304 may be used by content recommendation module 128 to determine the behavior of the user with short form content 306. For example, for the first user if the user watch less than 95% of the short form content, content recommendation module 128 may deduce that the user did not like the short form content presented to the user.

Machine learning model 324 may be configured to generate short form content recommendation 336 based on one or more of content representation 326, content representation 328, metadata representation 330, interaction representation 332, or user data representation 334. Content representation 326, content representation 328, metadata representation 330, and interaction representation 332 may be associated with the last N media content that the user has interacted with. In some aspects, an indication to whether content representation 326 or content representation 328 are associated with short form content or long form content may be provided as an input to machine learning model 324. In some aspects, machine learning model 324 may be trained to recognize long form content from short form content. In some aspects, an objective of machine learning model 324 is to increase the likelihood or conversation that the user like and watch the short form content.

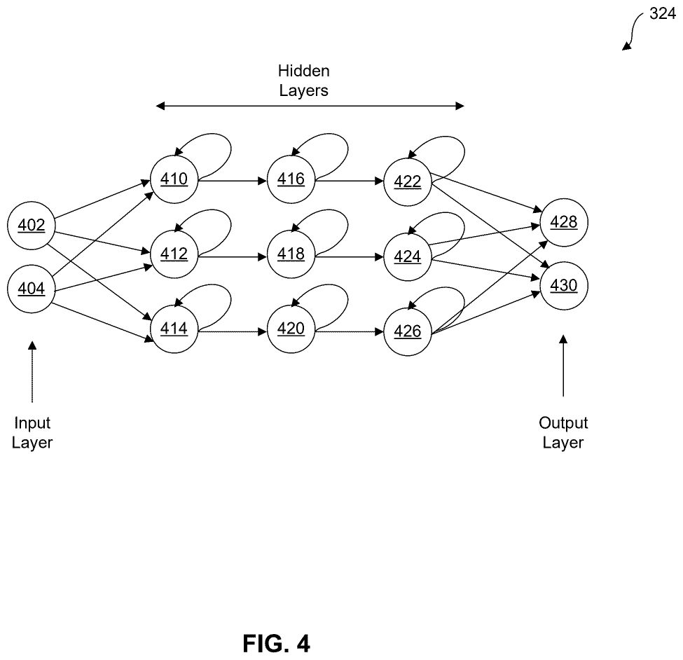

Machine learning model 324 may be a sequential recommendation model. In some aspects, the model may be a recurrent neural network (RNN) as further described in relation to FIG. 4. In some aspects, machine learning module 324 may be a long-short-term memory (LSTM), a gated recurrent unit GRU), or the like. In some aspects, machine learning module 324 may be a transformer-based model such as an attention mechanism based machine learning model. In some aspects, an output of machine learning model 324 may be a play probability or click probability for a short form content.

In some aspects, the output of machine learning model 324 may be one or more tags the user is interested in. Contents recommendation module 128 may pull from content server 120 short form content associated with the one or more tags. In some aspects, short form contents may be grouped and stored in content server 120 by tags. The pulled contents may be presented to the user via the GUI of media device 106.

FIG. 4 illustrates a block diagram of machine learning model 324, according to some embodiments. In some aspects, machine learning model 324 may be a sequential neural network such as a recurrent neural networks (RNN). Machine learning model 324 may be trained to generate a recommendation. For example, machine learning model 324 may be trained to generate a sequence of short form contents. As shown in FIG. 4, machine learning model 324 comprises a plurality of nodes 402-430 (also referred to as neurons). In the example shown in FIG. 4, machine learning model 324 is depicted as a fully recurrent neural network. However, it is noted that machine learning model 324 may comprise other types of machine learning models including, but not limited to, long short-term memory (LSTM) and recursive neural network.

Each node of nodes 402-430 may be associated with an edge coupling the node to another node of nodes 402-430. Each edge is associated with a weight, which emphasizes the importance of a particular node couple thereto. The weights of the RNN may be randomly initialized and may be learned through training on a training data set. The training data set may include historical data associated with the users. In some aspects, all metadata associated with content representation 326 and content representation 328 may be used during the training.

Machine learning model 324 may comprise an input layer, one or more hidden layers, and an output layer. Each of the input player, the one or more hidden layers, and the output layer may include one or more nodes. In FIG. 4, nodes 402 and 404 may represent the input layer. The input layer may receive input data (e.g., content representation 326, content representation 328, metadata representation 330, interaction representation 332, or user data representation 334, as shown in FIG. 3). Nodes 410-414 may represent a first hidden layer. Nodes 416-420 may represent a second hidden layer. Nodes 422-426 may represent a third hidden layer. Machine learning model 324 may include any number of hidden layers. Nodes 428-430 may represent the output layer. The output layer may output a recommendation for the media content (e.g., a probability of play or a representation of a short form content). In some aspects, backpropagation through time (BPTT) may be used to train machine learning model 324.

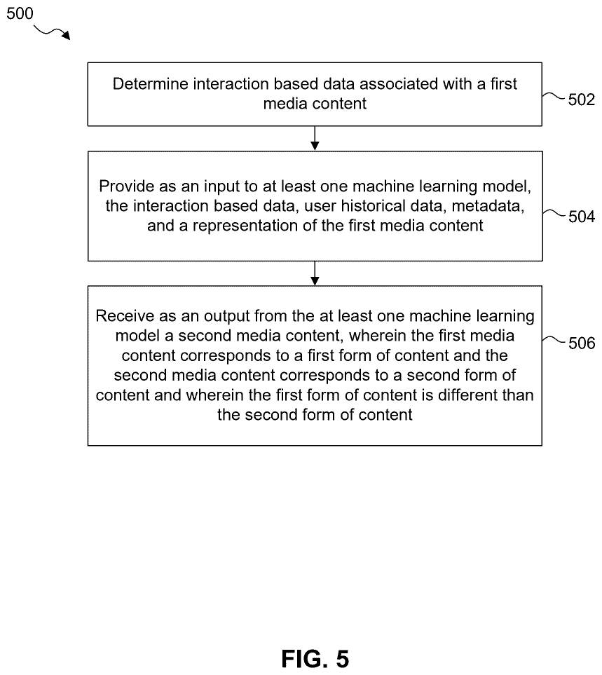

FIG. 5 is a flowchart for a method 500 for generating a recommendation of a media content item of a first form of content based on user interactions with a second form of content, according to an embodiment. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

Method 500 shall be described with reference to FIG. 1. However, method 500 is not limited to that example embodiment.

In 502, interaction based model 320 may determine interaction based data (e.g., interaction representation 332) based on the user interaction with a first media content. The first media content may be one or more media contents from long form content 304. In some aspects, the first media content may include the last N media content of long form that the user interacted with.

In 504, interaction based model 320 may provide as an input to machine learning model 324 the interaction based data. In addition, long form content model 314 may provide as input to machine learning model 324 a representation of the first media content (e.g., content representation 326 associated with the first media content). User data model 322 may provide as input to machine learning model 324 user historical data indicative of the user behavior with media contents of the first form and the second form of the contents. The historical data may include the one or more metrics generated by user data model 322. Metadata model 318 may provide as an input to machine learning model 324 metadata associated with the first media content.

In 506, machine learning model 324 may generate as an output a representation of a second media content of the first form (e.g., short form). The second media content may be a subset of one or more media contents of the long form. In some aspects, the output may include a sequence of media contents of the first form. For example, the output may include a sequence of short form video contents.

In some aspects, content recommendation module 128 may be used in a variety of areas. For example, content recommendation module 128 may be a playlist generator for short form contents. In some aspects, the playlist may be instantiated as a series of visual tiles of recommended short form content 336. The tiles may be arranged by some selected ordering system (e.g., popularity) and may be arranged in content groups or categories, such as “trending”, “top 10”, “newly added”, and the like.

In some aspects, the user may access short form content and recommended short form content 336 by clicking on a tile presented to the user via the GUI of media device 106. Once the user clicks on the tile, content recommendation module 128 may generate recommended short form content 336. The short content (e.g., user generated video content) may be output to the user sequentially.

In some aspects, the user may provide to content recommendation module 128 via the GUI a genre or a type of short form content the user is interested with. In some aspects, a plurality of tiles may be presented to the user (e.g., arranged in a row in the GUI). In some aspects, each tile of the plurality of tiles may be associated with a genre or type of short form. Once the user selects a tile, the associated genre or type may be provided as an input to machine learning model 324. In some aspects, the plurality of tiles presented to the user may be identified based on the user preference. For example, if the user is interested in “comedy” and “travel”, the user may be presented with two tiles: a first tile and a second tile. The first tile may include media contents of the short form associated with “comedy” and the second tile may include media contents of the short form associated with “travel”. In some aspects, the plurality of tiles may include the top N popular genres of short form media contents. As discussed above, user selection of a tile of a particular genre of short form media content may be added to user interaction data 310 and used to generate further short form content recommendation to the user.

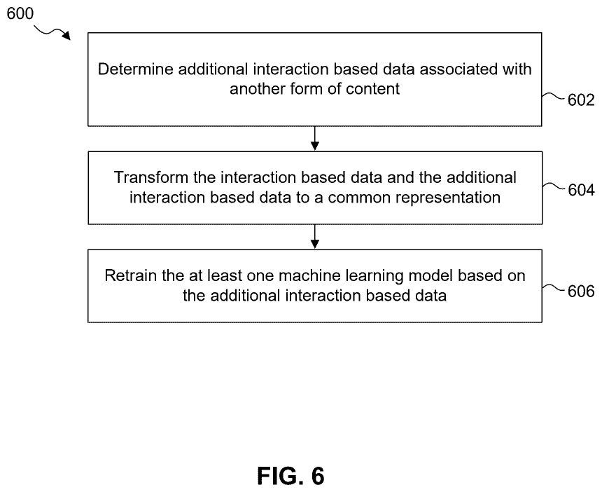

FIG. 6 is a flowchart for a method 600 for training machine learning model 324, according to an embodiment. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art.

Method 600 shall be described with reference to FIG. 1. However, method 600 is not limited to that example embodiment.

In 602, interaction based model 320 determines additional interaction based data associated with the second form of content based on user interactions with a media content of the short form.

In 604, interaction based model 320 transforms the interaction data and the additional interaction based data to a common representation. Common representation may refer to embedding that may be input to machine learning model 324.

In 606, machine learning model 324 is retrained using the additional interaction based data.

### Example Computer System

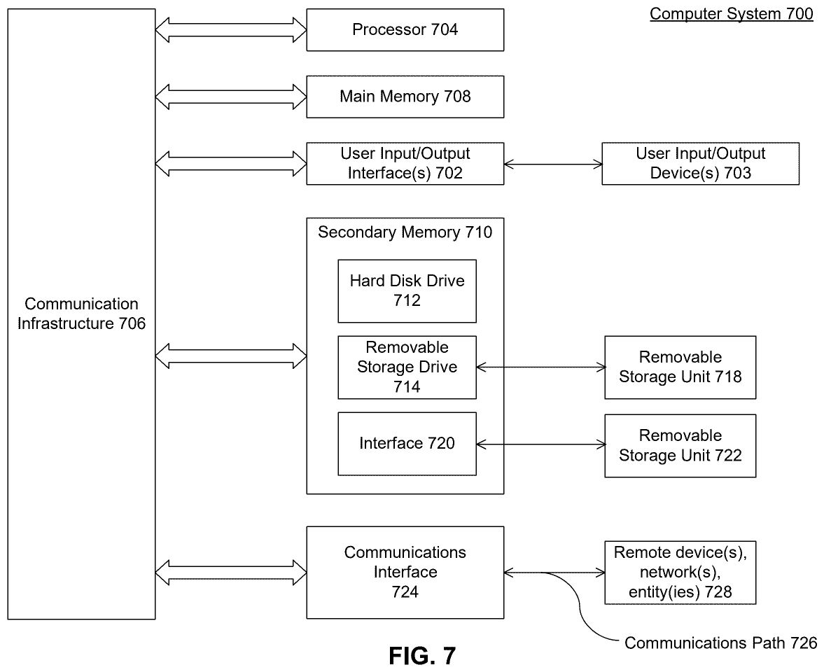

Various embodiments may be implemented, for example, using one or more well-known computer systems, such as computer system 700 shown in FIG. 7. For example, one or more of media device 106, remote control 110, content servers 120, system servers 126, content recommendation module 128, long form content model 314, short form content model 316, metadata model 318, interaction based model 320, user data module 322, and machine learning model 324 may be implemented using combinations or sub-combinations of computer system 700. Also or alternatively, one or more computer systems 700 may be used, for example, to implement any of the embodiments discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system xx00 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700 or processor(s) 704), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

### Conclusion

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A computer-implemented method for generating a recommendation for a media content of a first form of content based on user interactions with a second form of content, comprising:
determining, by at least one computer processor, interaction based data associated with the second form of content based on an interaction of a user with a first media content;
providing, as an input to at least one machine learning model, the interaction based data, a representation of the first media content, user historical data indicative of a user behavior with media contents of the first form of content or the second form of content, and metadata associated with the first media content;
receiving, as an output from the at least one machine learning model, one or more tags indicative of a user interest; and
identifying a second media content of the first form of content based on the one or more tags, wherein the first form of content is of a different length than the second form of content and wherein the second media content is not associated with the first media content.

2. The computer-implemented method of claim 1, further comprising:
determining additional interaction based data associated with the first form of content based on interactions of the user with the second media content; and
retraining the at least one machine learning model based on the additional interaction based data.

3. The computer-implemented method of claim 2, further comprising:
transforming the interaction based data associated with the second form of content and the additional interaction based data associated with the first form of content to a common representation.

4. The computer-implemented method of claim 1, wherein the first form of content is a short form of content and the second form of content is a long form of content.

5. The computer-implemented method of claim 4, wherein the media content of the first form of content is a subset of a media content of the second form of content.

6. The computer-implemented method of claim 1, wherein the at least one machine learning model includes a sequential machine learning model.

7. The computer-implemented method of claim 1, wherein the output of the at least one machine learning model comprises a sequence of short form video contents.

8. The computer-implemented method of claim 1, wherein the metadata associated with the first media content represents one of: a title of a first media content item; a category of the first media content item; a genre of the first media content item; a rating of the first media content; or cast information.

9. A system comprising:
one or more memories;
at least one processor each coupled to at least one of the one or more memories and configured to perform operations comprising:
determining interaction based data associated with a second form of content based on an interaction of a user with a first media content;
providing, as an input to at least one machine learning model, the interaction based data, a representation of the first media content, user historical data indicative of a user behavior with media contents of the first form of content or the second form of content, and metadata associated with the first media content;
receiving, as an output from the at least one machine learning model, one or more tags indicative of a user interest; and
identifying a second media content of the first form of content based on the one or more tags, wherein the first form of content is of a different length than the second form of content and wherein the second media content is not associated with the first media content.

10. The system of claim 9, wherein the operations further comprise:
determining additional interaction based data associated with the first form of content based on interactions of the user with the second media content; and
retraining the at least one machine learning model based on the additional interaction based data.

11. The system of claim 10, wherein the operations further comprise:
transforming the interaction based data associated with the second form of content and the additional interaction based data associated with the first form of content to a common representation.

12. The system of claim 9, wherein the first form of content is a short form of content and the second form of content is a long form of content.

13. The system of claim 12, wherein a media content of the first form of content is a subset of a media content of the second form of content.

14. The system of claim 9, wherein the at least one machine learning model includes a sequential machine learning model.

15. The system of claim 9, wherein the output of the at least one machine learning model comprises a sequence of short form video contents.

16. A non-transitory computer-readable medium having instructions stored thereon that, when executed by at least one computing device, cause the at least one computing device to perform operations comprising:
determining interaction based data associated with a second form of content based on an interaction of a user with a first media content;
providing, as an input to at least one machine learning model, the interaction based data, a representation of the first media content, user historical data indicative of a user behavior with media contents of the first form of content or the second form of content, and metadata associated with the first media content;
receiving, as an output from the at least one machine learning model, one or more tags indicative of a user interest; and
identifying a second media content of the first form of content based on the one or more tags, wherein the first form of content is of a different length than the second form of content and wherein the second media content is not associated with the first media content.

17. The non-transitory computer-readable medium of claim 16, wherein the operations further comprise:
determining additional interaction based data associated with the first form of content based on interactions of the user with the second media content; and
retraining the at least one machine learning model based on the additional interaction based data.

18. The non-transitory computer-readable medium of claim 16, wherein the first form of content is a short form of content and the second form of content is a long form of content.

19. The non-transitory computer-readable medium of claim 18, wherein a media content of the first form of content is a subset of a media content of the second form of content.

20. The computer-implemented method of claim 16, wherein the at least one machine learning model includes a sequential machine learning model.
